SEQUENCE LISTING (2 sequences)

SEQ ID NO: 1 - DNA, 31 bp, Artificial Sequence
  sense primer
ccaactcggtccgaaaccatgtcgtactacc

SEQ ID NO: 2 - DNA, 38 bp, Artificial Sequence
  antisense primer
ggctcactagttgtacttctcgacaagcttggtaccgc

(19) United States
(12) Patent Application Publication
(10) Pub. No.: US 2013/0004947 A1
(43) Pub. Date: Jan. 3, 2013

(54) LUCIFERASE-LINKED ANALYSIS OF DNA-METHYLTRANSFERASE, PROTEIN METHYLTRANSFERASE AND S-ADENOSYLHOMOCYSTEINE AND USES THEREOF

(76) Inventors: Vern L. Schramm, New Rochelle, NY (US); Ivan Hemeon, Surrey (CA)

(21) Appl. No.: 13/581,625

(22) PCT Filed: Mar. 8, 2011
(86) PCT No.: PCT/US2011/000430

§ 371 Date: Sep. 20, 2012

Related U.S. Application Data
(60) Provisional application No. 61/339,871, filed on Mar. 10, 2010.

(51) Int. Cl. G01N 21/76

(52) U.S. Cl. 435/6.1; 435/8

(57) ABSTRACT

The present invention relates to methods for detecting the activity of DNA (cytosine 5)-methyltransferase, protein methyltransferase or any enzyme that forms S-adenosyl-1-homocysteine (AdoHcy) as a product, and for screening for inhibitors of DNA (cytosine 5)-methyltransferase, protein methyltransferase and any enzyme that forms S-adenosyl-1-homocysteine (AdoHcy) as a product using luciferase-linked assays that convert the S-adenosyl-1-homocysteine (AdoHcy) product to a quantifiable luminescent signal.

### CROSS-REFERENCE TO RELATED APPLICATION

This application claims the benefit of U.S. Provisional Patent Application No. 61/339,871, filed Mar. 10, 2010, the content of which is hereby incorporated by reference into the subject application.

### STATEMENT OF GOVERNMENT SUPPORT

This invention was made with government support under grant numbers CA072444 and CA135405 awarded by the National Institutes of Health, U.S. Department of Health and Human Services. The government has certain rights in the invention.

### FIELD OF THE INVENTION

The present invention relates to methods for detecting DNA (cytosine 5)-methyltransferase activity and protein methyltransferase activity, and for screening for inhibitors of DNA (cytosine 5)-methyltransferase and protein methyltransferase. The invention also relates to detecting S-adenosylhomocysteine and screening inhibitors for enzymes that form S-adenosylhomocysteine as a product of the reaction.

### BACKGROUND OF THE INVENTION

Throughout this application various publications are referred to in parentheses. Full citations for these references may be found at the end of the specification immediately preceding the claims. The disclosures of these publications are hereby incorporated by reference in their entireties into the subject application to more fully describe the art to which the subject application pertains

AdoMet methyltransferases catalyze the transfer of a methyl group from S-adenosyl-1-methionine (AdoMet) to a methyl acceptor. Methyl acceptors include proteins, lipids, carbohydrates, oligonucleotides, and various small molecule metabolites. DNA (cytosine 5)-methyltransferases (DNMTs, EC 2.1.1.37) catalyze the transfer of a methyl group from AdoMet to a DNA substrate. This methyl group is transferred to the 5-position of a cytosine base when the cytosine precedes a guanosine residue at so-called “CpG islands” and effectively inhibits transcription of the associated gene (1). Thus, DNMTs are an important part of the mechanisms by which gene transcription is controlled in development, differentiation and cancer.

Human cancer cell lines possess hypermethylated CpG islands and it has been postulated that over-methylation decreases the transcription of tumor suppressor genes, promoting cancer proliferation (2). Inhibitors of DNMTs may provide a chemotherapeutic option by reducing CpG hypermethylation, allowing transcription of the tumor suppressor genes and reducing tumor proliferation (3). Development of DNMT inhibitors would be facilitated by an assay that can be used to quantitate DNMT activity and in inhibitor screens. The in vitro rates of DNA methylation by DNMTs are slow; therefore, the assay must be sensitive and also give stable signals.

Current DNMT assays are discontinuous, using [methyl-³H or -¹⁴C]AdoMet followed by separation of the methylated DNA product from unreacted AdoMet. Radioactive AdoMet provides high sensitivity but these assays exhibit high background levels and associated errors. Separation of DNA and AdoMet involves selective elution of unreacted AdoMet from a DNA-binding medium (4, 5). High background signals arise from nonspecific binding of AdoMet or AdoMet breakdown products to the medium. Proteins and lipids tend to add to the unreacted AdoMet background. Phenol/chloroform extraction followed by DNA precipitation reduces the contaminating proteins and lipids but introduces recovery errors (6, 7). Digestion of DNA with nuclease P₁ and alkaline phosphatase followed by HPLC separation of the nucleosides allows specific analysis of labeled 5-methylcytosine but is slow and error-prone (8). Biotinylated oligonucleotide substrates facilitate DNA isolation in avidin-coated 96-well plates (9, 10). However, the use of biotinylated substrates is not always desirable. A scintillation proximity assay avoids separation of AdoMet and DNA since DNA binds to yttrium silicate scintillant beads, but this approach also suffers from nonspecific AdoMet binding (11). Fluorescence-based assays use an anti-AdoHcy antibody in conjunction with AdoHcy bearing a fluorescent tag (12), or use S-adenosyl-1-homocysteine hydrolase (SAHH) to generate homocysteine that reacts with thiol-sensitive fluorophores (13, 14). These assays do not have a large range and require the use of thiol-free assay mixtures or the use of anaerobic conditions (13). Spectrophotometric assays have been developed for other AdoMet-dependent methyltransferases, one using SAHH and Ellman's reagent under discontinuous anaerobic conditions (15), and another using S-adenosyl-1-homocysteine nucleosidase to generate adenine from AdoHcy hydrolysis which is then converted to hypoxanthine using adenine deaminase (16). These cannot accommodate low AdoMet or DNA concentrations due to low sensitivity and also encounter interfering absorption from DNA substrates.

The present invention addresses the need for an improved DNMT assay, which can be used to screen for inhibitors of DNMT. The assay converts S-adenosylhomocysteine to a luciferase-based light signal and is suitable for application to any enzymatic reaction that forms S-adenosylhomocysteine as a product of an enzymatic reaction.

### SUMMARY OF THE INVENTION

The present invention provides methods of detecting the presence of DNA (cytosine 5)-methyltransferase (DNMT) or a protein methyltransferase (PMT) comprising: (a) enzyme-catalyzed transfer by DNMT or the PMT of a methyl group from S-adenosyl-1-methionine (AdoMet) to a DNA substrate or to a protein to produce S-adenosyl-1-homocysteine (AdoHcy); (b) hydrolyzing AdoHcy to adenine by 5′-methylthioadenosine nucleosidase (MTAN); (c) converting adenine to adenosine 5′-monophosphate (AMP) by adenine phosphoribosyl transferase (APRTase) in the presence of 5-phospho-α-thribosyl-1-pyrophosphate (PRPP); (d) converting AMP to adenosine 5′-triphosphate (ATP) by pyruvate orthophosphate dikinase (PPDK) in the presence of phosphoenolpyruvate (PEP) and inorganic pyrophosphate; and (e) reacting ATP with luciferin and O₂ in the presence of luciferase to produce AMP and a luminescent signal, wherein the presence of the luminescent signal indicates the presence of DNMT or the PMT.

The invention further provides methods of determining whether or not a compound is an inhibitor of DNA (cytosine 5)-methyltransferase (DNMT) or an inhibitor of a protein methyltransferase (PMT) comprising carrying out any of the methods disclosed herein for detecting the presence of DNMT or PMT in the presence of the compound and in the absence of the compound, wherein a decrease in the luminescent signal in the presence of the compound is indicative that the compound is an inhibitor of DNMT or PMT, and wherein a lack of decrease in the luminescent signal in the presence of the compound is indicative that the compound is not an inhibitor of DNMT or PMT.

The assay of the present invention converts S-adenosylhomocysteine to a luciferase-based light signal and is suitable for application to any enzymatic reaction that forms S-adenosylhomocysteine as a product of an enzymatic reaction.

### BRIEF DESCRIPTION OF THE FIGURES

FIG. 1. Schematic overview of the AdoHcy detection assay. AdoHcy is formed from AdoMet-dependent DNA methylation via DNMT and is converted to adenine using MTAN. The adenine is converted to AMP in an APRTase-catalyzed reaction with PRPP, then to ATP using PPDK with phosphoenolpyruvate. The ATP then reacts with luciferin and O₂ in a firefly luciferase-catalyzed process to generate a stable light signal for quantification as the resulting AMP is continuously cycled to ATP.

FIG. 2A-2B. AdoHcy standards: (A) 36 pmol AdoHcy in 25 μL DNMT assay buffer and 25 μL continuous assay buffer measured in the kinetic acquisition mode of the luminometer at room temperature. Signal reached maximum value within 90 s. (B) AdoHcy standard curve obtained by mixing 25 μL AdoHcy solutions in DNMT assay buffer (0.24-800 pmol) with 25 μL continuous assay buffer, incubating at room temperature for several minutes, and then measuring luminescence in the discontinuous format.

FIG. 3A-3B. Continuous assay measurements on 4 U M.SssI CpG methyltransferase (45 nM) and 1 μg poly(dIdC) at room temperature: (A) Reaction time course with increasing AdoMet concentrations. (B) Initial rates fit to Michaelis-Menten equation.

FIG. 4A-4E. Continuous assay measurements on human DNMTs at room temperature. Initial rates fit to Morrison equation for tight binding substrates: (A) 1 μg poly(dIdC), 492 nM DNMT3L-CD-DNMT3b, varied AdoMet concentration. (B) 10 μM AdoMet, 492 nM DNMT3L-CD-DNMT3b, varied poly(dIdC) concentration. (C) 10 μM AdoMet, 490 nM DNMT3L-CD-DNMT3a, varied poly(dIdC) concentration. (D) 1 μg poly(dIdC), 516 nM DNMT1, varied AdoMet concentration. (E) 35 μM AdoMet, 516 nM DNMT1, varied poly(dIdC) concentration.

FIG. 5A-5B. Initial rates for 258 nM DNMT1, 6 μg poly(dIdC), 300 μL total volume at room temperature and at 37° C. measured by discontinuous assay: (A) 682 nM AdoMet, luciferase-linked AdoHcy assay. (B) 672 nM [methyl-³H]-AdoMet, radiometric filter paper assay.

### DETAILED DESCRIPTION OF THE INVENTION

The invention provides a method of detecting the presence of DNA (cytosine 5)-methyltransferase (DNMT) or a protein methyltransferase (PMT) or any enzyme that forms S-adenosyl-1-homocysteine (AdoHcy) as a product comprising:

(a) enzyme-catalyzed transfer by DNMT or PMT of a methyl group from S-adenosyl-1-methionine (AdoMet) to a DNA substrate or to a protein to produce S-adenosyl-1-homocysteine (AdoHcy), or enzyme-catalyzed transfer by any enzyme that forms S-adenosyl-1-homocysteine (AdoHcy) as a product;

(b) hydrolyzing AdoHcy to adenine by 5′-methylthioadenosine nucleosidase (MTAN);

(c) converting adenine to adenosine 5′-monophosphate (AMP) by adenine phosphoribosyl transferase (APRTase) in the presence of 5-phospho-α-d-ribosyl-1-pyrophosphate (PRPP);

(d) converting AMP to adenosine 5′-triphosphate (ATP) by pyruvate orthophosphate dikinase (PPDK) in the presence of phosphoenolpyruvate (PEP) and inorganic pyrophosphate; and

(e) reacting ATP with luciferin and O₂ in the presence of luciferase to produce AMP and a luminescent signal,

wherein the presence of the luminescent signal indicates the presence of DNMT or the PMT.

The AMP that is produced in step (e) can be used as a source of AMP in step (d).

In a preferred embodiment, MTAN is present in a concentration between 5 μM and 125 nm.

Luciferase is a common bioluminescent enzyme. Organisms from which luciferase can be obtained include, but are not limited to fireflies, bacteria (e.g. Vibrio fischeri), jellyfish (e.g. Aequorea victoria), beetles, and squid. In the preferred embodiment of the present invention, the luciferase is firefly luciferase.

Preferably, the luminescent signal that is produced has an intensity that is proportional to the amount of DNMT or PMT or the enzyme that forms S-adenosyl-1-homocysteine (AdoHcy) as a product over a range of 0.1-1000 pmol AdoHcy. Preferably, maximum luminescence is reached within 2 minutes.

DNMT or PMT or the enzyme that forms S-adenosyl-1-homocysteine (AdoHcy) as a product can be detected in a continuous assay or in a discontinuous assay.

Examples of PMT that can be detected include, but are not limited to, protein arginine N-methyltransferase, protein-glutamate O-methyltransferase, protein-histidine N-methyltransferase, protein-S-isoprenylcysteine O-methyltransferase, myelin basic protein-arginine N-methyltransferase, protein L-isoaspartyl methyltransferase, protein-S-isoprenylcysteine O-methyltransferase, and an enzyme that forms S-adenosyl-1-homocysteine (AdoHcy) as a product.

Methyl acceptors include proteins, lipids, carbohydrates, oligonucleotides, and various small molecule metabolites.

Examples of enzymes that form S-adenosyl-L-homocysteine (AdoHcy) as a product include, but are not limited to, histamine N-methyltransferase, phenylethanolamine N-methyltransferase, tryptamine N-methyltransferase, phosphatidylethanolamine N-methyltransferase, O-5-hydroxyindole-O-methyltransferase, acetylserotonin O-methyltransferase, catechol-O-methyl transferase, homocysteine betaine-homocysteine methyltransferase, homocysteine methyltransferase, phosphatidyl ethanolamine methyltransferase, histone methyltransferases and thiopurine methyltransferase.

The invention also provides a method of determining whether or not a compound is an inhibitor of DNA (cytosine 5)-methyltransferase (DNMT) or an inhibitor of a protein methyltransferase (PMT) or an inhibitor of an enzyme that forms S-adenosyl-1-homocysteine (AdoHcy) as a product, comprising carrying out any of the methods disclosed herein for detecting the presence of DNMT or PMT or an enzyme that forms S-adenosyl-1-homocysteine (AdoHcy) as a product, in the presence of the compound and in the absence of the compound, wherein a decrease in the luminescent signal in the presence of the compound is indicative that the compound is an inhibitor of DNMT or PMT or the enzyme that forms S-adenosyl-1-homocysteine (AdoHcy) as a product, and wherein a lack of decrease in the luminescent signal in the presence of the compound is indicative that the compound is not an inhibitor of DNMT or PMT or the enzyme that forms S-adenosyl-1-homocysteine (AdoHcy) as a product.

This invention will be better understood from the Experimental Details, which follow. However, one skilled in the art will readily appreciate that the specific methods and results discussed are merely illustrative of the invention as described more fully in the claims that follow thereafter.

### EXPERIMENTAL DETAILS

### Introduction

A sensitive luciferase-linked continuous assay was developed that converts the S-adenosyl-L-homocysteine (AdoHcy) product of DNA methylation to a quantifiable luminescent signal. The assay can be used under continuous or discontinuous conditions in high-throughput plate formats. 5′-Methylthioadenosine nucleosidase (MTAN) hydrolyzes AdoHcy to adenine which is converted to adenosine 5′-monophosphate (AMP) by adenine phosphoribosyl transferase (APRTase, EC 2.4.2.7) using 5-phospho-α-d-ribosyl-1-pyrophosphate (PRPP), then to adenosine 5′-triphosphate (ATP) by pyruvate orthophosphate dikinase (PPDK, EC 2.7.9.1) using phosphoenolpyruvate (PEP) and inorganic pyrophosphate. ATP production is coupled to firefly luciferase to give a stable luminescent signal by AMP cycling (17). This assay is linear over a broad range (0.1-1000 pmol AdoHcy). As AdoHcy is an inhibitor of AdoMet-dependent methyltransferases (18), its removal by MTAN also prevents product inhibition. The continuous nature of this assay eliminates product separation and sample preparation steps.

The kinetic properties are characterized for two highly active DNMTs, human DNMT1 and the bacterial M.SssI CpG methyltransferase, and two DNMTs of low activity, complexes of human DNMT3L with the catalytic domains of human DNMT3a and DNMT3b. The full-length human DNMT1 is thought to be responsible for maintaining the methylation pattern of the genome during cell division and genome replication (1). DNMT3a and DNMT3b are thought to play roles in de novo methylation of the genome during embryonic development and have also been implicated in cancers (1). Activation was characterized by human DNMT3L, a catalytically inactive accessory protein that interacts with DNMT3a and DNMT3b to enhance their activities.

### Materials and Methods

M.SssI CpG methyltransferase and AdoMet were purchased from New England Biolabs (Ipswich, Mass.). AdoMet was further purified by reverse-phase HPLC using a Waters C18 column (4.6×250 mm), 20% acetonitrile at 0.5 mL/min. Poly(2′-deoxyinosinic-2′-deoxycytidylic acid) was purchased from Sigma (Ashland, Mass.; Cat. No. P4929). Firefly luciferase ATP assay kit (ATPlite) and Betaplate Scint scintillation fluid were purchased from Perkin-Elmer, as was S-adenosyl-1-[methyl-³H]methionine with a specific activity of 70.8 Ci/mmol (Waltham, Mass.). EDTA-free Complete protease inhibitor cocktail tablets and PhosSTOP phosphatase inhibitor tablets were purchased from Roche Applied Science (Indianapolis, Ind.). Recombinant S. cerevisiae APRTase bearing an N-terminal His₆ tag and recombinant Clostridium symbiosum PPDK were prepared as previously described (17). Synthetic DNA constructs coding for DNMTs and MTAN were purchased from DNA 2.0 (Menlo Park, Calif.). The Gateway LR Clonase II enzyme mix was purchased from Invitrogen (Carlsbad, Calif.). Plasmid DNA was isolated and purified using the Qiagen HiSpeed plasmid midi kit (Valencia, Calif.). Ni-NTA agarose was purchased from Qiagen. Corning 96-well non-binding surface microplates were purchased through Fisher Scientific (Pittsburgh, Pa.). Protein concentrations were measured by Bradford assay in comparison with bovine serum albumin (BSA) standards obtained from Bio-Rad (Hercules, Calif.). All other reagents used were from Fisher Scientific or Sigma-Aldrich and were the highest quality available. Luminescence was measured using a Glomax 96-well luminometer from Promega (Madison, Wis.). Scintillation counting was performed using a TriCarb 2910TR Liquid Scintillation Counter from Perkin Elmer.

Expression and Purification of Human DNMT1. Human DNMT1 expression constructs containing an N-terminal His₆ tag and an rTEV protease cleavage site were subcloned from the pFastBac HTa plasmid (a generous gift of Prof Keith D. Robertson, University of Florida). Polymerase chain reaction of human DNMT1 cDNA was used to incorporate an SpeI restriction endonuclease site at the 3′ end (sense primer: 5′-CCAACTCGGTCCGAAACCATGTCGTACTACC -3′ (SEQ ID NO:1) and antisense primer: 5′- GGCTCACTAGTTGTACTTCTCGACAAGCTTGGTACCGC -3′ (SEQ ID NO:2). The restriction sites are underlined). This PCR product was digested with RsrII and SpeI and ligated downstream of the polyhedrin promoter of a pFastDual vector that contains green fluorescent protein cDNA downstream of the p10 promoter (the generous gift of Dr. Kartik Chandran, Department of Microbiology and Immunology, Albert Einstein College of Medicine, (27)). The ligation of human DNMT1 was verified by DNA sequencing and contains an I311V mutation in human DNMT1 isoform b (GenBank Identifier: 4503351). The final pFastDual construct was transformed into DH10Bac E. coli (Invitrogen) to generate the recombinant Bacmid. The recombinant Bacmid was used to co-transfect and produce recombinant baculovirus in the SF9 cell line (maintained as a suspension culture in Sf-900 III serum free medium at 2° C.) according to the protocol provided in the Bac-to-Bac Baculovirus Expression System manual (Invitrogen). The titer of recombinant baculovirus was measured by an endpoint dilution assay. For protein expression, SF9 cells were grown in conical flasks at 120 rpm, 27° C. SF9 cells at a density of 2×106 mL−1 were infected at a multiplicity of infection between 1 and 5. The cells were harvested 96 hours post-infection, then lysed in RIPA buffer (PBS, 1% NP-40, 0.5% SDS, 0.5% sodium deoxycholate, 10% glycerol, Complete protease inhibitor cocktail tablet (Roche)) and were sonicated on ice 3×25 s using a Fisher Scientific model 500 sonicator at 20% duty cycle. Cellular debris was removed by centrifugation at 16,000 rpm for 30 min and the cleared supernatant was loaded on a 1 mL HisTrap FF crude His-tag affinity column (GE Healthcare). The column washed with buffer A (20 mM imidazole, 50 mM 4-(2-hydroxyethyl)-1-piperazineethanesulfonic acid (HEPES) pH 7.4, 200 mM NaCl) and human DNMT1 was eluted with a gradient of 20-500 mM imidazole in buffer A. Fractions were analyzed by SDS-PAGE and those containing human DNMT1 were combined and subjected to overnight dialysis in 50 mM HEPES pH 7.4, 200 mM NaCl and 2 mM dithiothreitol (DTT). The dialyzed human DNMT1 was concentrated to ˜5 mg/mL using an Amicon ultracentrifugal filter device, 10,000 MW cut off (Millipore).

Expression and Purification of Human DNMT3a Catalytic Domain (CD-DNMT3a). The catalytic domain of human DNMT3a was identified by sequence alignment with bacterial cytosine methyltransferases that consist mainly of catalytic domains as well as through previous reports of the mouse DNMT catalytic domains (20). A construct coding for a 286 amino acid C-terminal domain of human DNMT3a (residues 627-912 of human DNMT3a, NCBI accession number Q9Y6K1) containing an N-terminal His₆ tag with a thrombin cleavage site was purchased from DNA 2.0 in a pDONR221 Gateway donor vector (Invitrogen). The plasmid was amplified in E. coli DH5a cells and purified by HiSpeed midiprep (Qiagen) to afford pDONR221-CD-HDNMT3a. The gene encoding CD-DNMT3a was cloned into the pDEST14 Gateway destination/expression vector using the Gateway LR Clonase II enzyme mix (Invitrogen) which was amplified in E. coli One Shot OmniMAX 2T1 phage-resistant cells (Invitrogen) and purified by HiSpeed midiprep to afford pDEST14-CD-HDNMT3a. The expression vector was transformed into E. coli BL21 star (DE3) cells and were grown in 1 L Luria-Bertani (LB) media supplemented with 100 μg/mL ampicillin at 37° C., 200 rpm to a density of A600=0.5. The culture was cooled to 18° C. and expression was induced with 0.5 mM isopropyl β-D-1-thiogalactopyranoside (IPTG). After incubating at 18° C., 250 rpm for 15 h, the cells were harvested by centrifugation at 4,000 rpm for 20 min at 4° C. The cell pellet was resuspended in 25 mL lysis buffer (100 mM HEPES pH 8.0, 300 mM NaCl, 10 mM imidazole, 5% glycerol, 0.1% DTT, EDTA-free Complete protease inhibitor cocktail tablet (Roche), 0.1 mg/mL DNaseI, 0.1 mg/mL lysozyme) and passed through a French press (3×16,000 psi) followed by centrifugation at 16,000 g for 20 min at 4° C. The supernatant was loaded onto 2 mL Ni-NTA agarose resin (Qiagen) that had been equilibrated in running buffer (50 mM HEPES pH 8.0, 300 mM NaCl, 5% glycerol). The resin was washed with 30 mL running buffer supplemented with 100 mM imidazole and 0.1% DTT, then CD-DNMT3a was eluted in running buffer supplemented with 500 mM imidazole and 0.1% DTT. The purity of the fractions was monitored by SDS-PAGE. The first 3 mL 500 mM imidazole fraction was dialyzed against a storage buffer containing 20 mM HEPES pH 8.0, 250 mM NaCl, 5% glycerol, 0.1% DTT overnight at 4° C. and was then flash frozen in aliquots in dry ice/ethanol and stored at −80° C. Protein concentration was determined by Bradford assay (Bio-Rad). Approximately 1.5 mg purified protein was obtained from 1 L of culture.

Expression and Purification of Human DNMT3b Catalytic Domain (CD-DNMT3b). The catalytic domain for human DNMT3b was identified as described for CD-DNMT3a. A construct coding for a 286 amino acid C-terminal domain of human DNMT3b (residues 568-853 of human DNMT3b, NCBI accession number Q9UBC3) containing an N-terminal His₆ tag with a thrombin cleavage site was purchased from DNA 2.0 in a pDONR221 Gateway donor vector (Invitrogen). The gene was amplified (pDONR221-CD-HDNMT3b), cloned into the pDEST14 Gateway expression vector, and amplified again (pDEST14-CD-HDNMT3b) as described for CD-DNMT3a. The expression vector was transformed into E. coli BL21 (DE3) pLysS cells which were grown, induced, harvested, and lysed under the same conditions as described above. CD-DNMT3b was purified and dialyzed under identical conditions as described above except that it was eluted with running buffer supplemented with 100 mM ethylenediaminetetraacetic acid (EDTA) and 0.1% DTT and the second 3 mL fraction was dialyzed, then stored at −80° C. Approximately 2.2 mg purified protein could be obtained from 1 L of culture.

Expression and Purification of Human DNMT3L. A construct coding for the full-length human DNMT3L (NCBI accession number NP-037501) containing an N-terminal His₆ tag with a thrombin cleavage site was purchased from DNA 2.0 in a pDONR221 Gateway donor vector (Invitrogen). The gene was amplified (pDONR221-HDNMT3L), cloned into the pDEST14 Gateway expression vector, and amplified again (pDEST14-HDNMT3L) as described for CD-DNMT3a. The expression vector was transformed into E. coli BL21(DE3) cells which were grown, harvested, and lysed under the same conditions described above. The supernatant was loaded onto 2 mL Ni-NTA resin as described above and the column was washed with a step gradient from 25-1000 mM imidazole in running buffer with 0.1% DTT. Purity of the fractions were monitored by SDS-PAGE and pure fractions were pooled and dialyzed overnight against storage buffer at 4° C. followed by flash freezing of aliquots and storage at −80° C. Approximately 18 mg purified protein was obtained from 1 L of culture.

Expression and Purification of S. enterica MTAN. The gene encoding MTAN in Salmonella enterica was synthesized and cloned into pDONR221 vector by DNA 2.0 (Menlo Park, Calif.), incorporating an N-terminal His₆ tag sequence and terminal attB sequences. The gene was swapped into pDEST14 vector (amp^{R}) using Invitrogen Gateway Cloning Technology (Carlsbad, Calif.), and successful clones were transformed into BL21 (DE3) competent cells. Several colonies were screened for protein expression under IPTG induction, and glycerol stocks were prepared from the best expression clones. For protein expression, LB medium was seeded with an overnight culture of BL21 (DE3) grown in the presence of ampicillin (100 μg/mL), and incubated at 37° C. with shaking at 250 rpm. Induction was initiated at A₆₀₀=0.6 with 0.5 mM IPTG for 4 h. Cells were harvested by centrifugation at 4000 rpm for 20 min and resuspended in lysis buffer (40 mM TEA-HCl pH 7.8, 300 mM NaCl, 0.2 mg/mL lysozyme, 0.1 mg/mL DNaseI, protease inhibitors). Cells were lysed with three rounds of sonication for 15 s each round with 1 min cooling time between bursts. Cell debris was removed by centrifugation at 16,000 rpm for 30 min, and the cleared supernatant was loaded on a 5 mL Ni-NTA column equilibrated in lysis buffer. The column was washed with 5 column volumes of 10 mM imidazole in running buffer (20 mM TEA-HCl pH 7.8, 300 mM NaCl). Elution was done using a step gradient of 25 mM imidazole in running buffer with 250 mM imidazole in the final fraction. Fractions were analyzed by SDS-PAGE and pertinent fractions were pooled together and dialyzed overnight in 20 mM TEA-HCl pH 7.8, 50 mM NaCl. Glycerol was added to 10% of the volume prior to storage at −80° C.

AdoHcy to ATP Conversion Buffer. The 2×AdoHcy to ATP conversion buffer was prepared as previously described with minor modifications (17). In brief, 100 mL of buffer contained 100 mM Tris-acetate pH 7.7, 2 mM PEP, 2 mM sodium pyrophosphate, 2 mM PRPP, 15 mM (NH₄)₂SO₄, 15 mM (NH₄)₂MoO₄, and phosphatase inhibitors (Roche PhosSTOP, 10 tablets). A 4:1 cellulose:charcoal mixture was suspended in water and packed into a disposable mini-column to a bed volume of 1.5 mL, through which a 10 mL aliquot of the previously prepared buffer was passed at 2 mL/min to remove traces of adenine, AMP, and ATP. Treated buffer was filtered (0.2 μm) and stored in 1 mL aliquots at −80° C. Immediately prior to use, the 2× conversion buffer was completed by additions to give final concentrations of 10 mM MgSO₄, 6 U APRTase, 18 U PPDK, and 250 nM MTAN and an increase in volume of 14 μL.

DNMT Kinetics using Continuous Luciferase Assay. Continuous assay buffer (2×) was prepared by adding 200 μl luciferin/luciferase (ATPlite) to 1 mL of the AdoHcy to ATP conversion buffer and warmed to room temperature. To 25 μL of this mixture was added AdoMet and the DNA substrate in DNMT assay buffer (25 mM HEPES pH 7.6, 50 mM KCl, 5% glycerol, 0.1% DTT) in a 96-well non-binding surface microplate. The mixture was incubated at room temperature for 3 min to permit any contaminating adenine, AMP, ATP or 5′-methylthioadenosine (MTA) to be converted to a stable background light signal as measured in the kinetic acquisition mode of the luminometer for 3 min. DNMT was added to give a final volume of 50 μL. After 3 min, the luminescent signal was measured for the following 3 min. Reactions with the less active DNMT3L-CD-DNMT3a and DNMT3L-CD-DNMT3b complexes were performed in triplicate. Initial rates were calculated by subtracting the background rate from that obtained after DNMT addition. Initial rates were fitted to the Morrison equation for tight binding substrates with the exception of data obtained while using M.SssI CpG methyltransferase which were fit to the Michaelis-Menten equation. The Morrison equation was used as high enzyme concentrations were necessary and it could no longer be assumed that free substrate concentration was equal to total substrate concentration. The kinetic parameters Kₘ and Vₘₐₓ were obtained from these fits after converting the luminescent rate (RLU/s) to an enzymatic rate (pmol AdoHcy/h) using the AdoHcy standard curve. The AdoHcy standard curve was constructed by mixing 25 μL of DNMT assay buffer containing varied concentrations of AdoHcy with 25 μL of continuous assay buffer, incubating for several minutes, and then measuring the luminescence of each sample in the discontinuous acquisition mode of the luminometer. Values were background corrected using a mixture containing no AdoHcy.

DNMT1 Rate Measurement using Discontinuous Luciferase Assay. DNMT1 was added to a solution of 682 nM AdoMet and 1 μg poly(dIdC) in DNMT assay buffer to a concentration of 258 nM in 300 μL total volume which had been equilibrated to 22° C. or 37° C. A control reaction containing no DNMT1 was also performed at 37° C. 15 μL aliquots of the reaction were quenched with 5 μL of 100 mM HCl at 2 min intervals from 2 to 10 min in triplicate. These were neutralized with 5 μL of 100 mM KOH and were mixed with 25 μL of 2×AdoHcy to ATP conversion buffer and incubated at room temperature for several minutes. 20 μL of each mixture were then mixed with 80 μL of ATPlite in a 96-well non-binding surface microplate. These mixtures were incubated at room temperature for several minutes and their luminescence was measured in the single measurement mode of the luminometer. The luminescent signal (RLU) was converted to pmol AdoHcy by constructing an AdoHcy standard curve in which 15 μL aliquots of AdoHcy solutions with varied concentrations in DNMT assay buffer were treated as above. Values were background corrected with a mixture containing no AdoHcy.

DNMT1 Rate Measurement using Radiometric Assay. The same two reactions were prepared as above for the discontinuous luciferase assay with the exception that 672 nM S-adenosyl-1-[methyl-³H]methionine was used in place of non-radioactive AdoMet. 15 μL aliquots were removed from each reaction in triplicate at 2 min intervals from 2 to 8 min and spotted on 2.3 cm diameter Whatman DE81 filter paper circles which were allowed to dry for 30 min. The circles were washed with 0.2 M NH₄HCO₃ (4×2 mL), water (4×2 mL), and absolute ethanol (1×2 mL); each wash lasted 5 min before decanting the liquid. Circles were then dried for 1 h, then placed in scintillation vials and covered with 10 mL Betaplate Scint scintillation fluid. Radioactivity was measured on a Tricarb scintillation counter and background was corrected with a no-enzyme control. A conversion factor of 12 CPM/fmol was used.

### Results and Discussion

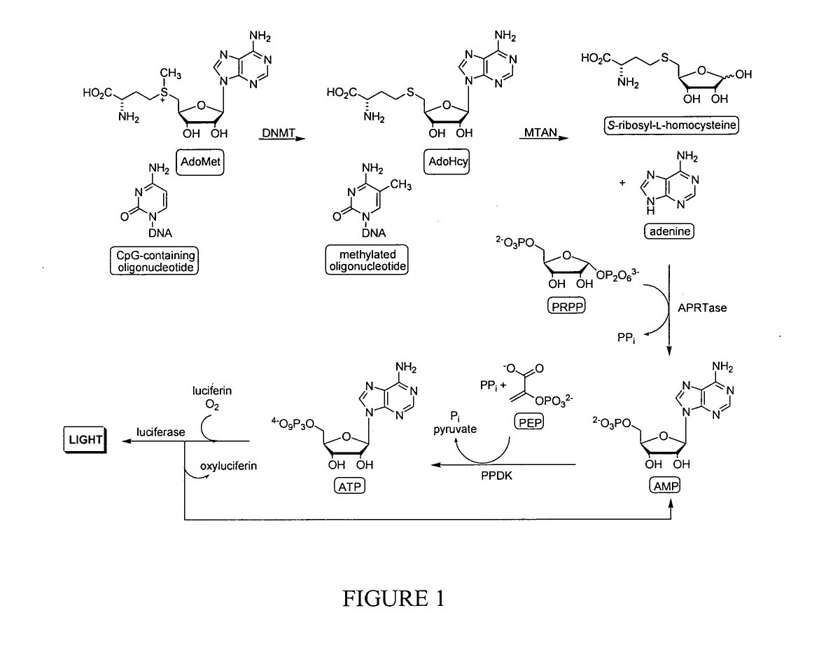

Detection and Quantification of AdoHcy. Initial tests established that recombinant MTAN from S. enterica hydrolyzed AdoHcy to give adenine in the AdoHcy to ATP continuous assay buffer to generate a light signal (FIG. 1). AdoHcy (25 μL) solutions were mixed in 96-well microplates with continuous assay buffer (25 μL) containing MTAN concentrations varying from 6 μM to 125 nM and the luminescence measured in the continuous kinetic acquisition mode. In this concentration range, MTAN hydrolyzed AdoHcy solutions to completion in less than 2 min; thus, 125 nM MTAN was used for subsequent assays. MTAN does not hydrolyze AdoMet, permitting variable AdoMet concentrations in this assay.

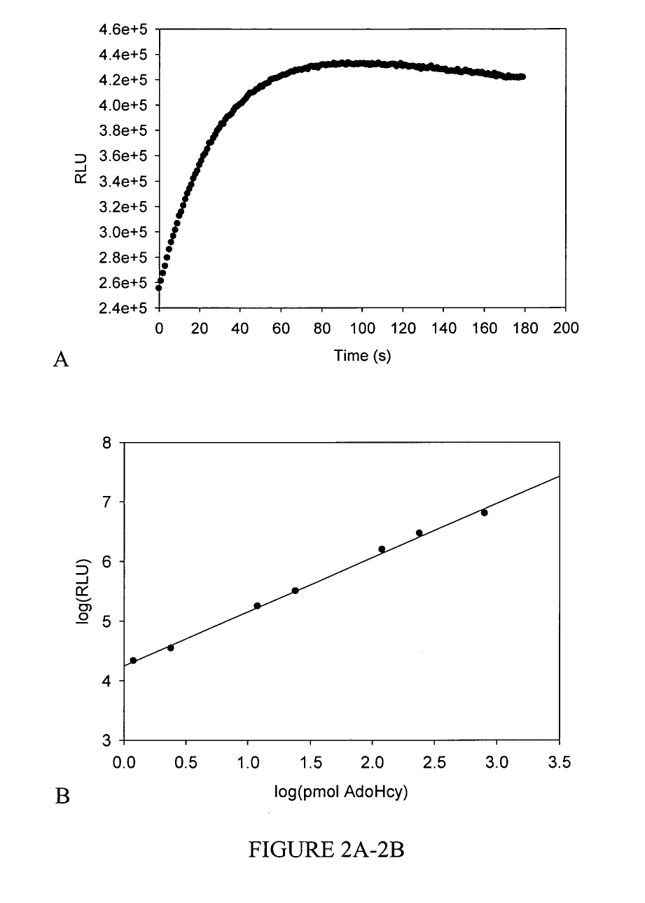

A standard curve was constructed by mixing 25 μL of the 2× continuous assay buffer with 25 μL AdoHcy standard solutions in a 96-well plate (FIG. 2A). Luminescence measured in the continuous acquisition mode gave maximum luminescence from the AdoHcy signal within 2 min. Light output as a function of AdoHcy (pmol) gave a linear correlation (FIG. 2B). Alternatively, all solutions could be mixed in several wells and the luminescence measured after several minutes of incubation in the discontinuous acquisition mode of the luminometer to construct the same curve (FIG. 2B). The AdoHcy standard curve matched that obtained from adenine standard solutions, indicating that the coupling between AdoHcy and adenine is complete in terms of ATP yield (17). The range of this assay is broad as solutions containing 0.1-1000 pmol of AdoHcy fall within the linear range of the standard curve.

Expression of Human DNMTs. Full-length human DNMT3a and DNMT3b are composed of 912 and 853 amino acids, respectively. The 286 amino acid C-terminal catalytic domains were expressed for kinetic analysis. These domains were modified to contain an N-terminal His₆ tag and a thrombin cleavage site. The catalytic domain was identified through sequence alignments of DNMT3a and DMNT3b from humans and mice which gave excellent homology in the C-terminal domains. All sequences contained a cysteine residue at the position for the proposed catalytic nucleophile (eg. 706 in human DNMT3a). The C-terminal regions of human DNMT3a/3b also aligned well with bacterial (cytosine 5)-methyltransferases. The bacterial DNMTs are smaller than mammalian DNMTs and consist primarily of the catalytic domain. The catalytic domains of mouse DNMT3a and DNMT3b have been previously expressed in E. coli (19, 20).

Synthetic gene constructs for CD-DNMT3a and CD-DNMT3b were transformed into strains of E. coli competent cells and it was found that BL21 star (DE3) cells afforded the highest yield of CD-DNMT3a while BL21 (DE3) pLysS cells were best for CD-DNMT3b expression. Expression was best at low temperatures (18° C., 18 h) as much of the protein was expressed into inclusion bodies at 37° C. and could not be refolded after purification under denaturing conditions. Purification with a room-temperature Ni-NTA agarose column eluted CD-DNMT3a with 500 mM imidazole and CD-DNMT3b with 100 mM EDTA after washing away non-His₆-tagged proteins with 100 mM imidazole. Pure fractions were dialyzed into a buffer containing 0.1% DTT as significant protein precipitation occurred during dialysis in the absence of DTT.

DNMT3L was also expressed since this protein has been reported to interact with DNMT3a and DNMT3b in both full-length and catalytic domain constructs and to enhance their activities (21). Expression of DNMT3L from a synthetic gene construct in E. coli BL21 (DE3) cells gave protein expression after 3 h induction at 37° C. and 2.5-fold increased expression after overnight expression at 18° C. DNMT3L was purified by elution from a Ni-NTA agarose column with an imidazole gradient.

Human DNMT1 was also expressed. It is known to be significantly more active than DNMT3a, DNMT3b or their mixtures with DNMT3L. As the catalytic domain of DNMT 1 has been reported to be inactive (22), the full-length 1620 amino acid construct was expressed in SF9 cells using a baculovirus-based expression system. Purification of DNMT1 was also achieved by elution from a Ni column with an imidazole gradient.

DNMT Activity in Continuous Assays. The use of HPLC-purified AdoMet improved the accuracy and reproducibility of the AdoHcy production assays. AdoMet is unstable at neutral and alkaline pH and degrades via an intramolecular reaction giving 5′-methylthioadenosine (MTA) and homoserine lactone and a hydrolytic reaction giving adenine and S-pentosylmethionine (23). MTA is a substrate for MTAN and is hydrolyzed to give adenine. Thus, both breakdown pathways produce intermediates that contribute to the background in the luciferase-linked DNMT assay. Commercial AdoMet sources contain up to 10% MTA and/or adenine. HPLC purification reduced these to below 0.5%.

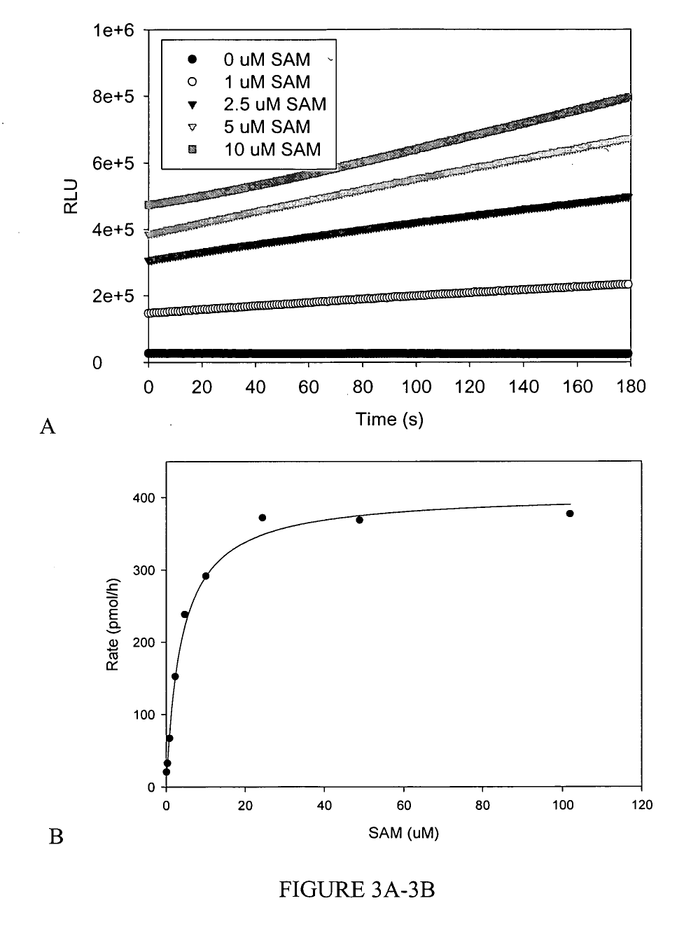

AdoMet instability makes it necessary to measure a background decomposition rate for initial rate measurements. This was accomplished by incubating the complete reaction mixture without the methyltransferase for 3 min, then to measure the background luminescence for 3 min (FIG. 3A). This approach gives a stable linear background signal. The DNMT reaction is then initiated by the addition of the enzyme followed by another 3 min incubation, then 3 min measurement of luminescence. The order of DNA and DNMT addition can be reversed to allow background measurement of the AdoMet and DNMT solutions. The 3 minute incubation period after reaction initiation eliminates a lag phase between enzyme addition and formation of a linear signal. The reason for this lag phase is attributed to enzyme-DNA binding and conformational changes since pre-incubating DNMTs with the DNA substrate often shortens or eliminates the lag phase. Increasing the amounts of coupling enzymes and/or the amount of ATPlite does not affect the lag phase.

Bacterial M.SssI CpG methyltransferase was used to benchmark the assay because of its high activity. The commonly used synthetic oligonucleotide poly(2′-deoxyinosinic-2′-deoxycytidylic acid) (poly(dIdC)) was selected as the DNA substrate. It is reported to have high activity with DNMTs (24). Initial reaction rates were measured with a constant amount of poly(dIdC) while AdoMet concentration was varied in order to measure its Kₘ. The luminescent signal increased linearly with time as the AdoHcy product of DNA methylation was converted to ATP. The rate increased with increasing AdoMet concentration (FIG. 3A). Conversion of AdoHcy to a luminescent signal has the added benefit of removing the reaction product as AdoHcy is known to inhibit DNMTs. Initial rates with 1 μg poly(dIdC) and 4 U M.SssI CpG methyltransferase (45 nM) were plotted against AdoMet concentration and fit to the Michaelis-Menten equation (FIG. 3B). This gave a Kₘ for AdoMet of 3.5±0.32 μM and a k_{cat} of 179±2.8 h⁻¹, consistent with reported values (Table 1) (6).

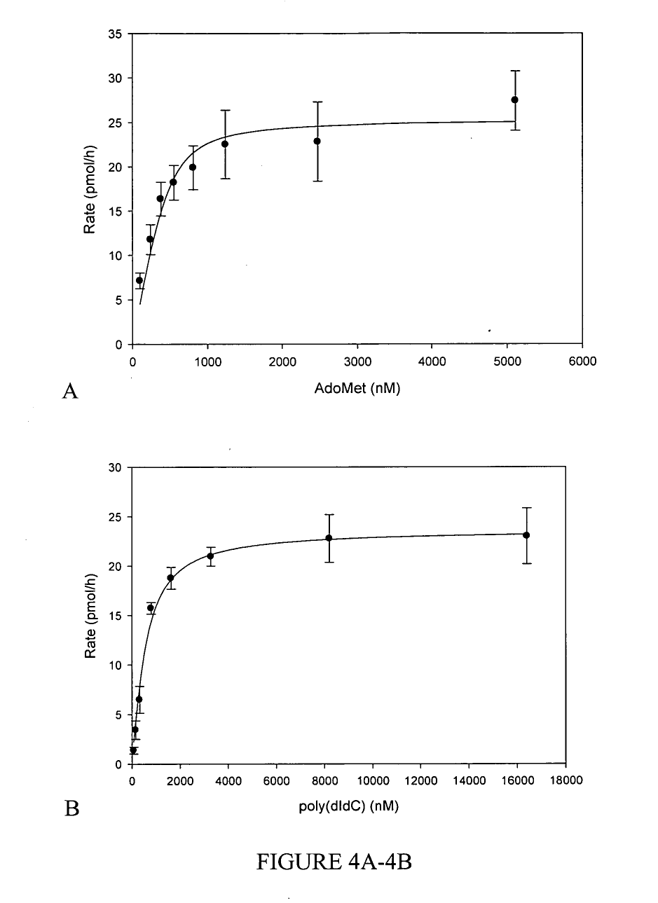

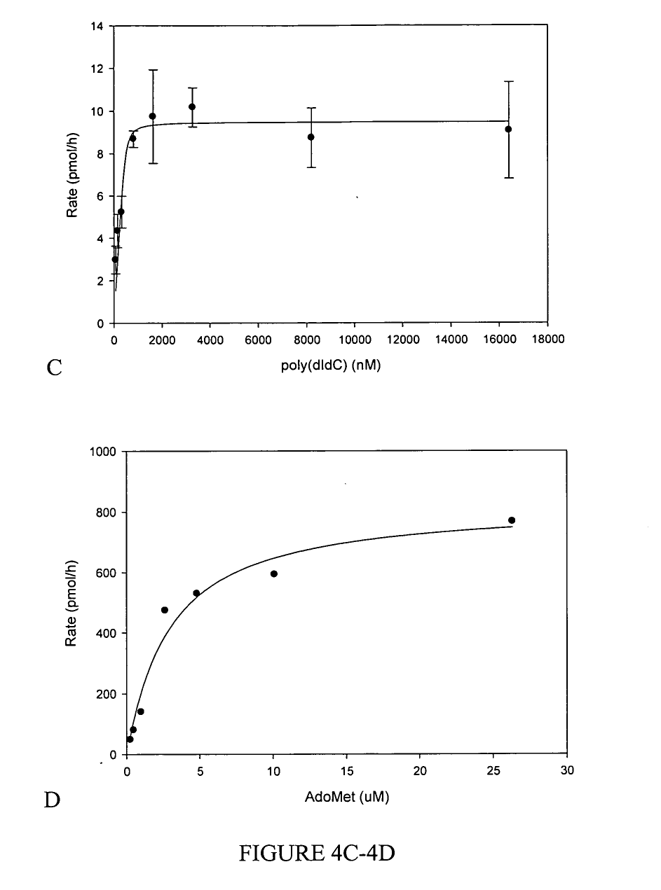

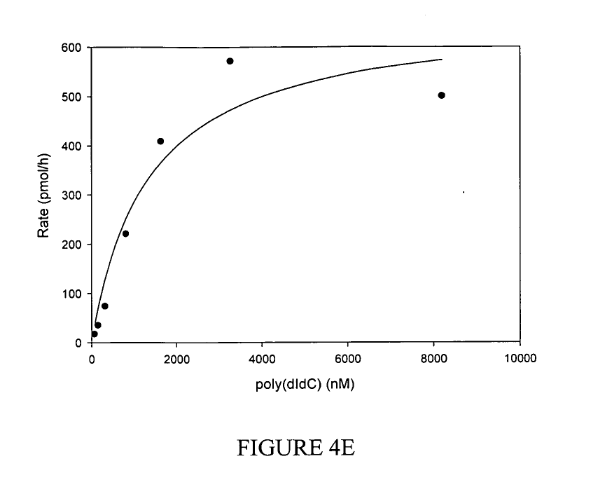

Initial reaction rates for CD-DNMT3a and CD-DNMT3b alone, even at high substrate and enzyme concentrations, gave low activity. The activities of these constructs were increased to readily measurable levels by combining 1:1 molar ratios of the enzymes with DNMT3L and incubating for 40 min at room temperature. Optimal enzyme concentration was explored by measuring initial rates at 10 μM AdoMet and 0.5 μg poly(dIdC) while varying the concentration of CD-DNMT3b+DNMT3L. Enzyme concentration over the range of 0.2-4.0 μM gave initial rates proportional to enzyme concentration. Michaelis-Menten curves with varying AdoMet and poly(dIdC) concentrations were analyzed with 500 nM CD-DNMT3 and DNMT3L (FIGS. 4A and 4B, respectively). The dIdC concentration of poly(dIdC) was calculated based on an average polymer length of 2100 by (1200-3000 by range) giving an average double-stranded molecular weight of 2.57×10⁶ g/mol and a dIdC base pair concentration of 0.82 nmol dIdC/μg poly(dIdC) (7.8 nM DNA polymer in the assay). Initial reaction rates gave poor fits to the Michaelis-Menten equation since this equation includes the assumption that the substrate concentration is unchanged by enzyme binding and is constant during the course of the reaction. When the amount of enzyme used is significant relative to the concentration of substrate; corrections can be made by fitting to the Morrison equation for substrate depletion (25):

$$v = {V}_{max} \frac{( [ E ] + [ S ] + {K}_{m} ) - \sqrt{{( [ E ] + [ S ] + {K}_{m} )}^{2} - 4 [ E ] [ S ]}}{2 [ E ]} .$$

The equation accounts for substrate bound to the enzyme, allowing analysis of kinetic constants at high relative enzyme concentration. These fits gave an AdoMet Kₘ of 69±40 nM, a poly(dIdC) Kₘ of 330±58 nM, and k_{cat} of 1.0±0.07 h^{'1} (Table 1). For CD-DNMT3a with DNMT3L (490 nM) and 1 μg poly(dIdC), the reaction rate was unchanged until AdoMet concentrations were below 100 nM, where initial rates decreased rapidly with decreasing AdoMet concentrations, indicating a Kₘ value of less than 50 nM. These data fit poorly to both the Michaelis-Menten and Morrison equations. The data fit well to a two-term Morrison equation containing two Kₘ and two Vₘₐₓ terms. Thus, altered AdoMet concentration may have effects on the CD-DNMT3a-DNMT3L equilibrium in addition to catalytic site saturation. Data obtained with 490 nM CD-DNMT3a-DNMT3L, 10 μM AdoMet, and varying poly(dIdC) concentrations were fit to the Morrison equation to give a poly(dIdC) Kₘ of 19±36 nM and a k_{cat} of 0.39±0.02 h⁻¹ (FIG. 4C; Table 1). The enzyme mixtures, CD-DNMT3a-DNMT3L and CD-DNMT3b-DNMT3L, have substantially lower Kₘ values than the bacterial M.SssI CpG methyltransferase. The AdoMet Kₘ for CD-DNMT3a-DNMT3L is more than 70-fold lower than that for M.SssI CpG methyltransferase. Both human CD-DNMT3-DNMT3L mixtures have k_{cat} values two to three orders of magnitude lower than that for the M.SssI CpG methyltransferase.

Full-length human DNMT1 prefers hemimethylated DNA as a substrate in which one of the two strands contains methylated cytosine, however, it is more active on unmethylated poly(dIdC) DNA than CD-DNMT3a or CD-DNMT3b in complex with DNMT3L (24). DNMT1 was used at a concentration of 516 nM with while varying AdoMet and DNA concentrations (FIGS. 4D and 4E). Initial rate data were fit to the Morrison equation to give a AdoMet Kₘ of 2.7±0.7 μM, a poly(dIdC) Kₘ of 840±400 nM, and a k_{cat} of 28±3 h⁻¹ (Table 1). These values are similar to those for the bacterial M.SssI CpG methyltransferase, although its k_{cat} value is 6.5 times greater than that for human DNMT1, consistent with reported values (6, 26). This difference between DNMT1 and the CD-DNMT3a-DNMT3L and CD-DNMT3b-DNMT3L complexes suggest the need for additional regulatory elements for activation of the human DNMT3 sequences.

The results with several DMNTs demonstrate the effectiveness of this luciferase-linked assay for characterizing DNA methyltransferase reactions. Measurement of highly- and less-active DNA methyltransferases is facilitated by the broad dynamic range of the assay. Finally, product inhibition by AdoHcy is prevented by its continual removal.

DNMT1 Activity Using Discontinuous Assays. Discontinuous assays have applications in endpoint assays and inhibitor screens. They are also suited to the measurement of kinetic data under experimental conditions not suited to luminometer reaction conditions.

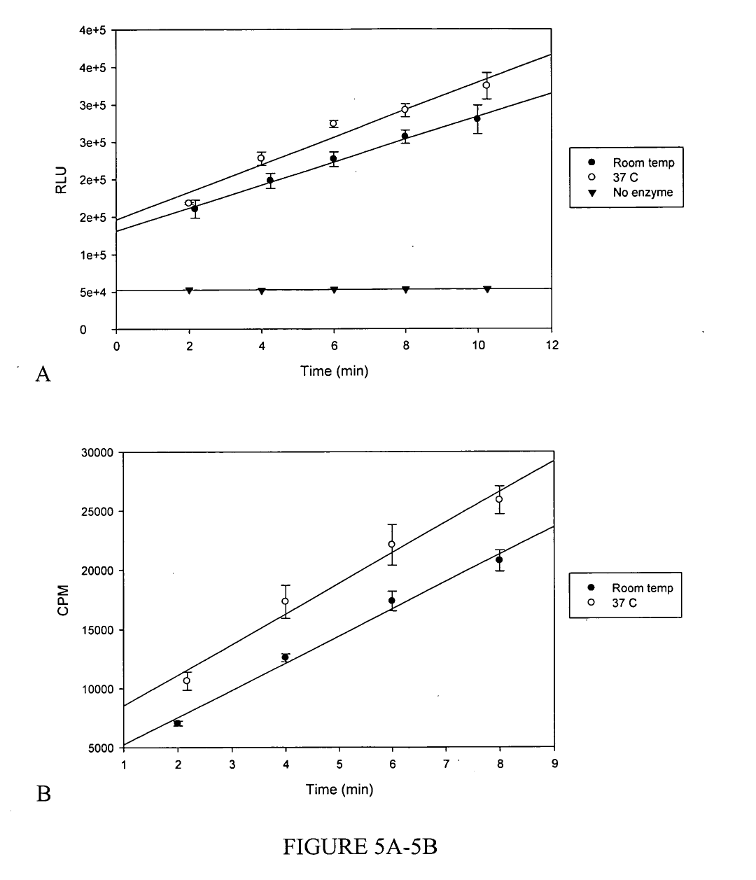

Initial reaction rates for human DNMT1 were measured both at room temperature and at 37° C. Assays used large-scale (300 μL total volume) reaction mixtures containing 682 nM AdoMet, 6 μg poly(dIdC), and 258 nM DNMT1. Aliquots were removed every two min (2-10 min) and quenched with 100 mM HCl. Aliquots from a no-enzyme control were treated in the same manner. The aliquots were neutralized with 100 mM KOH, mixed with one volume of 2×AdoHcy to ATP conversion buffer and incubated at room temperature for ˜3 min. Aliquots of these samples were mixed with four volumes of ATPlite in a 96-well plate format to convert the ATP into a luminescent signal. After incubation at room temperature for ˜3 min, the luminescence of each sample was measured and an initial rate plot was constructed (FIG. 5A). Initial rates measured in RLU/s were converted to units of pmol/h with an AdoHcy standard curve constructed under the same assay conditions (Table 2). The rate at 37° C. was greater than that at room temperature, 7.5 vs 6.3 pmol/h, respectively. These rates are lower than the 30 pmol/h obtained from an identical reaction performed using the continuous luciferase-linked assay, thus the components of the continuous assay favor the methyltransfer reaction. The discontinuous rates were readily measured even at low AdoMet concentrations, and the assay is suitable for automated screening. Initial rate plots (eg. FIG. 5A) could be constructed under various substrate concentrations using the luciferase-linked assay under discontinuous conditions in order to obtain kinetic data as in FIG. 4.

Parallel reactions were performed with 672 nM [methyl-³H]AdoMet to compare the initial rates from the luciferase assay with those obtained from the radiometric filter paper assay (4, 5). Reactions were limited to approximately 700 nM AdoMet because of the concentration of the [methyl/-³H]AdoMet stock solution. The luciferase-linked assays were performed at the same AdoMet concentration. Two min aliquots (2-8 min) were spotted on 2.3 cm diameter Whatman DE81 filter paper circles. After drying (30 min), the circles were washed with 0.2 M NH₄HCO₃, water, and ethanol. The dried circles were analyzed for radioactivity in a scintillation counter. Background-correction for a no-enzyme control gave reaction rates (FIG. 5B). Initial rates in were converted to pmol/h using [methyl-³H]AdoMet standards (Table 2). Initial rates of 11.6 pmol/h at 22° C. and 13.0 pmol/h at 37° C. are similar to those obtained in other assays.

A light-based continuous detection assay has been developed for the detection of AdoHcy. The assay will provide facile quantitation of any AdoMet-based methyltransferase reaction. Here, the assay is demonstrated for DNA methyltransferases. This assay uses an MTAN that hydrolyzes AdoHcy to give adenine and S-ribosylhomocysteine but does not interact with AdoMet. Adenine is then converted to ATP using APRTase and PPDK. ATP is quantitated by a luciferase-catalyzed reaction with luciferin. This reaction produces a stable luminescent signal since the AMP product is cycled to ATP to sustain the signal. This assay has the added benefit of removing AdoHcy from reaction mixtures to prevent product inhibition. The assay is capable of detecting sub-picomole quantities of AdoHcy and has a broad dynamic range to over 1000 pmol of AdoHcy. This continuous assay is a unique development for AdoMet-dependent methyltransferases because of the sensitivity, dynamic range and link to light production with recycling of AMP for stable light signal. The range of applications is broadened by use under both continuous and discontinuous conditions, as needed for chemical library screening and hit validation.

TABLE 1
Kinetic parameters for DNMTs as measured using
continuous assay at room temperature

| Enzyme | Kₘ^{AdoMet} (nM)^{a} | Kₘ^{DNA} (nM)^{b} | Vₘₐₓ (pmol/h) | k_{cat} (h⁻¹) |
|---|---|---|---|---|
| M.SssI | 3500 ± 320 | N/D^{c} | 404 ± 6.4 | 179 ± |
| | | | | 2.8 |
| DNMT1 | 2660 ± 750 | 837 ± 404 | 726 ± 75 | 28.1 ± |
| | | | | 2.91 |
| CD-DNMT3a- | <50 | 19.5 ± 36 | 9.47 ± 0.551 | 0.387 ± |
| DNMT3L | | | | 0.0225 |
| CD-DNMT3b- | 69 ± 40 | 329 ± 57.9 | 24.6 ± 1.6 | 1.00 ± |
| DNMT3L | | | | 0.065 |

^{a}Near saturating poly(dIdC) concentration. dIdC base pair concentration = 16.4 μM.
^{b}Near saturating AdoMet concentration used: 35 μM for DNMT1, 10 μM for CD-
DNMT3a and CD-DNMT3b in complexes with DNMT3L.
^{c}Not done

TABLE 2
Initial rates of 258 nM DNMT1 reacting
with 682 nM AdoMet or 672 nM
[methyl/-³H]-AdoMet,
1 μg poly(dIdC) per 50 μL as
measured under various conditions.

| Assay | Rate (pmol/h) |
|---|---|
| Continuous | 30.1 |
| Disc. Luciferase 22° C. | 6.26 |
| Disc. Luciferase 37° C. | 7.52 |
| Radiometric 22° C. | 11.6 |
| Radiometric 37° C. | 13.0 |

### REFERENCES

1. Miranda T B, Jones P A (2007) DNA methylation: the nuts and bolts of repression. J Cell Physiol 213:384-390.

2. Gopalakrishnan S, Van Emburgh B O, Robertson K D (2008) DNA methylation in development and human disease. Mutat Res 647:30-38.

3. Goffin J, Eisenhauer E (2002) DNA methyltransferase inhibitors—state of the art. Ann Oncol 13:1699-1716.

4. Datta J, et al. (2009) A new class of quinoline-based DNA hypomethylating agents reactivates tumor suppressor genes by blocking DNA methyltransferase 1 activity and inducing its degradation. Cancer Res 69:4277-4285.

5. Kareta M S, Botello Z M, Ennis J J, Chou C, Chedin F (2006) Reconstitution and mechanism of the stimulation of de novo methylation by human DNMT3L. J Biol Chem 281:25893-25902.

6. Lee W J, Zhu B T (2006) Inhibition of DNA methylation by caffeic acid and chlorogenic acid, two common catechol-containing coffee polyphenols. Carcinogenesis 27:269-277.

7. Morey S R, et al. (2006) DNA methylation pathway alterations in an autochthonous murine model of prostate cancer. Cancer Res 66:11659-11667.

8. Hogarth L A, et al. (2008) The effect of thiopurine drugs on DNA methylation in relation to TPMT expression. Biochem Pharmacol 76:1024-1035.

9. Roth M, Jeltsch A (2000) Biotin-avidin microplate assay for the quantitative analysis of enzymatic methylation of DNA by DNA methyltransferases. Biol Chem 381:269-272.

10. Gowher H, Jeltsch A (2001) Enzymatic properties of recombinant Dnmt3a DNA methyltransferase from mouse: the enzyme modifies DNA in a non-processive manner and also methylates non-CpA sites. J Mol Biol 309:1201-1208.

11. Baker M R, Zarubica T, Wright HT, Rife J P (2009) Scintillation proximity assay for measurement of RNA methylation. Nucleic Acids Res 37:e32.

12. Graves T L, Zhang Y, Scott J E (2008) A universal competitive fluorescence polarization activity assay for S-adenosylmethionine utilizing methyltransferases. Anal Biochem 373:296-306.

13. Wang C, Leffler S, Thompson D H, Hrycyna C A (2005) A general fluorescence-based coupled assay for S-adenosylmethionine-dependent methyltransferases. Biochem Biophys Res Commun 331:351-356).

14. Collazo E, Couture J-F, Bulfer S, Trievel R C (2005) A coupled fluorescent assay for histone methyltransferases. Anal Biochem 342:86-92.

15. Hendricks C L, Ross J R, Pichersky E, Noel J P, Zhou Z S (2004) An enzyme-coupled colorimetric assay for S-adenosylmethionine-dependent methyltransferases. Anal Biochem 326:100-105.

16. Dorgan K M, et al. (2006) An enzyme-coupled continuous spectrophotometric assay for S-adenosylmethionine-dependent methyltransferases. Anal Biochem 350:249-255.

17. Sturm M B, Schramm V L (2009) Detecting ricin: sensitive luminescent assay for ricin A-chain ribosome depurination kinetics. Anal Chem 81:2847-2853.

18. Bacolla A, Pradhan S, Roberts R J, Wells R D (1999) Recombinant human DNA (cytosine-5) methyltransferase. J Biol Chem 274:33011-33019.

19. Gowher H, Jeltsch A (2002) Molecular enzymology of the catalytic domains of the Dnmt3a and Dnmt3b DNA methyltransferases. J Biol Chem 277:20409-20414.

20. Jia D, Jurkowska R Z, Zhang X, Jeltsch A, Cheng X (2007) Structure of Dnmt3a bound to Dnmt3L suggests a model for de novo DNA methylation. Nature 449:248-251

21. Gowher H, Liebert K, Hermann A, Xu G, Jeltsch A (2005) Mechanism of stimulation of catalytic activity of Dnmt3a and Dnmt3b DNA-(cytosine-C5)-methyltransferases by Dnmt3L. J Biol Chem 280:13341-13348.

22. Fatemi M, Hermann A, Pradhan S, Jeltsch A (2001) The activity of the murine DNA methyltransferase Dnmt1 is controlled by the interaction of the catalytic domain with the N-terminal part of the enzyme leading to an allosteric activation of the enzyme after binding to methylated DNA. J Mol Biol 309:1189-1199.

23. Hoffman J L (1986) Chromatographic analysis of the chiral and covalent instability of S-adenosyl-L-methionine. Biochemistry 25:4444-4449.

24. Svedruzic Z M, Reich N O (2005) DNA cytosine C5 methyltransferase Dnmt1: catalysis-dependent release of allosteric inhibition. Biochemistry 44:9472-9485.

25. Morrison J F, Walsh C T (1988) The behavior and significance of slow-binding enzyme-inhibitors. Adv Enzymol Relat Areas Mol Biol 61:201-301.

26. Flynn J, Glickman J F, Reich N O (1996) Murine DNA cytosine-C5 methyltransferase: pre-steady- and steady-state kinetic analysis with regulatory DNA sequences. Biochemistry 35:7308-7315.

27. Li J, Rahmeh A, Morelli M, Whelan S P J (2008) A conserved motif in region V of the large polymerase proteins of nonsegmented negative-sense RNA viruses that is essential for mRNA capping. J Virol 82:775-784.

1. A method of detecting the presence of DNA (cytosine 5)-methyltransferase (DNMT) or a protein methyltransferase (PMT) or an enzyme that forms S-adenosyl-1-homocysteine (AdoHcy) as a product comprising:
(a) enzyme-catalyzed transfer by DNMT or PMT or an enzyme that forms S-adenosyl-1-homocysteine (AdoHcy) as a product of a methyl group transfer from S-adenosyl-1-methionine (AdoMet) to a DNA, protein or other substrate to produce S-adenosyl-1-homocysteine (AdoHcy);
(b) hydrolyzing AdoHcy to adenine by 5′-methylthioadenosine nucleosidase (MTAN);
(c) converting adenine to adenosine 5′-monophosphate (AMP) by adenine phosphoribosyl transferase (APRTase) in the presence of 5-phospho-α-d-ribosyl-1-pyrophosphate (PRPP);
(d) converting AMP to adenosine 5′-triphosphate (ATP) by pyruvate orthophosphate dikinase (PPDK) in the presence of phosphoenolpyruvate (PEP) and inorganic pyrophosphate; and
(e) reacting ATP with luciferin and O₂ in the presence of luciferase to produce AMP and a luminescent signal,
wherein the presence of the luminescent signal indicates the presence of DNMT or the PMT.

2. The method of claim 1, wherein MTAN is present in a concentration between 5 μM and 125 nM.

3. The method of claim 1, wherein the luciferase is firefly luciferase.

4. The method of claim 1, wherein the luminescent signal has an intensity that is proportional to the amount of DNMT or PMT or the enzyme that forms S-adenosyl-1-homocysteine (AdoHcy) as a product over a range of 0.1-1000 pmol AdoHcy.

5. The method of claim 1, wherein maximum luminescence is reached within 2 minutes.

6. The method of claim 1, wherein AMP produced in step (e) is used as a source of AMP in step (d).

7. The method of claim 1, wherein DNMT or PMT or the enzyme that forms S-adenosyl-1-homocysteine (AdoHcy) as a product is detected in a continuous assay.

8. The method of claim 1, wherein a PMT is detected.

9. The method of claim 1, where PMT is selected from the group consisting of protein arginine N-methyltransferase, protein-glutamate O-methyltransferase, protein-histidine N-methyltransferase, protein-S-isoprenylcysteine O-methyltransferase, myelin basic protein-arginine N-methyltransferase, protein L-isoaspartyl methyltransferase, protein-S-isoprenylcysteine O-methyltransferase, and any other enzyme that forms S-adenosyl-1-homocysteine (AdoHcy) as a product.

10. The method of claim 1, wherein DNMT is detected.

11. The method of claim 1, wherein an enzyme that forms S-adenosyl-L-homocysteine (AdoHcy) as a product is detected.

12. The method of claim 11, wherein the enzyme is selected from the group consisting of histamine N-methyltransferase, phenylethanolamine N-methyltransferase, tryptamine N-methyltransferase, phosphatidylethanolamine N-methyltransferase, O-5-hydroxyindole-O-methyltransferase, acetylserotonin O-methyltransferase, catechol-O-methyl transferase, homocysteine betaine-homocysteine methyltransferase, homocysteine methyltransferase, phosphatidyl ethanolamine methyltransferase, histone methyltransferases and thiopurine methyltransferase.

13. A method of determining whether or not a compound is an inhibitor of DNA (cytosine 5)-methyltransferase (DNMT) or an inhibitor of a protein methyltransferase (PMT) or an inhibitor of any enzyme that forms S-adenosyl-1-homocysteine (AdoHcy) as a product, comprising carrying out the method of any of claims 1-12 in the presence and in the absence of the compound, wherein a decrease in the luminescent signal in the presence of the compound is indicative that the compound is an inhibitor of DNMT or PMT or the enzyme that forms S-adenosyl-1-homocysteine (AdoHcy) as a product, and wherein a lack of decrease in the luminescent signal in the presence of the compound is indicative that the compound is not an inhibitor of DNMT or PMT or the enzyme that forms S-adenosyl-1-homocysteine (AdoHcy) as a product.

14. The method of claim 13, wherein the compound is an inhibitor of DNMT.

15. The method of claim 13, wherein the compound is an inhibitor of PMT.

16. The method of claim 15, where the PMT is selected from the group consisting of protein arginine N-methyltransferase, protein-glutamate O-methyltransferase, protein-histidine N-methyltransferase, protein-S-isoprenylcysteine O-methyltransferase, myelin basic protein-arginine N-methyltransferase, protein L-isoaspartyl methyltransferase, protein-S-isoprenylcysteine O-methyltransferase, and any enzyme that forms S-adenosyl-1-homocysteine (AdoHcy) as a product.

17. The method of claim 13, wherein the compound is an inhibitor of an enzyme that forms S-adenosyl-L-homocysteine (AdoHcy) as a product.

18. The method of claim 17, wherein the enzyme is selected from the group consisting of histamine N-methyltransferase, phenylethanolamine N-methyltransferase, tryptamine N-methyltransferase, phosphatidylethanolamine N-methyltransferase, O-5-hydroxyindole-O-methyltransferase, acetylserotonin O-methyltransferase, catechol-O-methyl transferase, homocysteine betaine-homocysteine methyltransferase, homocysteine methyltransferase, phosphatidyl ethanolamine methyltransferase, histone methyltransferases and thiopurine methyltransferase.
